(19) United States
(12) Patent Application Publication
(10) Pub. No.: US 2001/0053944 A1
(43) Pub. Date: Dec. 20, 2001

(54) Audio internet navigation system

(76) Inventors: Michael B. Marks, South Orleans, MA (US); Joel Marks, Sherman Oaks, CA (US)

Correspondence Address: Brad I Golstein, Metro88 Partnership, 20755 Plummer Street, Chatsworth, CA, 91311, US

(21) Appl. No.: 09/819,679

(22) Filed: Mar. 29, 2001

Related U.S. Application Data
(60) Provisional application No. 60/193,372, filed on Mar. 31, 2000.

(51) Int. Cl. G06F 17/00

(52) U.S. Cl. 700/94

(57) ABSTRACT

A method for searching, selecting, and playing audio program playlists. A station that is affiliated with a network of associated stations provides a top channel of programming which includes a default playlist. An alternate playlist is prepared as each item in the top channel is received by a listener. If the listener reacts to an item of the default playlist in a prescribed manner, the listener is automatically switched to a sidechannel where the alternate playlist is immediately started. The sidechannel is typically personalized based on a user preference that reflects how the top channel or the sidechannel has been modified. The sidechannel maintains the character of the station on whose top channel it is based. A further sidechannel may be created for a user of a station that reflects an alternate user preference at that respective station. Therefore according to one example a listener can switch between different channels of any station, a top channel of general programming, and one or more distinct sidechannels of personalized programming if the listener has modified a playlist of that station to cause a sidechannel to be created. Each affiliated station may offer these services to listeners. A standardized control device operates in a common manner among affiliated stations so that a listener may navigate among them in a familiar manner. The control device includes modify and search functions. A display of the control device shows the different aspects of navigation in consistent locations of the display screen. A sidechannel may include reduced commercial programming, where a user earns credits toward reduced commercials by paying a fee or performing certain actions such as responding to ads.

### FIELD OF THE INVENTION

The present invention concerns a device, method and payment system for selecting and modifying real time audio content and other information from the Internet.

### BACKGROUND OF THE INVENTION

Audio information and entertainment content are available from multiple sources including broadcast radio, and personal audio collections stored as CD's, MP3 files, tapes and other storage media. Increasingly, audio programming is also available on various Internet web sites. High speed data connections are making more of this “Internet Audio” practical to use. Internet audio is currently accessed by visiting a web site that provides such programming. A PC computer incorporating a player such as Windows Media Player 7 or RealPlayer 8 or a purpose built device such as a Sonicbox or Kerbango tuner is used to select an audio web site and the programming within it.

Some audio sites assist a user in compiling a personal playlist by enabling the user to combine and modify generic, genre specific, playlists. This modification may work in conjunction with a player device (hardware or software GUI) wherein a user may signal preferences in real time to the content provider such that the content provider may, at a later time, modify an existing personal channel of the user. However, before using such services, the user must first create a personal channel (also called a personal radio station or personal playlist) by specifying preferred artists. Collaborative filtering techniques may be used to build a complete channel from the specified preferences. Launch.com is one example of such a service provider. Another example is Sonicnet.com. In addition to requiring a user to enter personal preferences prior to listening to a personalized channel, these providers require personal contact information such as an email address. Other services providers such as Netradio.com enable a user with an installed player to immediately tune in to streaming audio channels without registration or the option to create a personal playlist.

Internet audio listening is thus similar to many other web surfing activities, at least until a user has made the effort to set up a computer to present and play desired program types.

Companies such as Voquette and Audio Basket provide tools, technology and support for creating a personal playlist from multiple sources (including web sites), storing and automatically updating such playlist and enabling a user to access and listen to the playlist on a variety of devices. Listener registration is required.

The search service offered by Napster and other peer to peer models offer methods for finding specific content when the content is known. However, such methods are much less helpful when only a genre is known.

Many Internet audio sites try to mix visual information with the featured audio content. The result approaches a type of interactive television. This is a well-accepted model for infotainment programming. However when the user's intent is purely a listening experience the equipment and visual content is a distraction from the primary goal of downloading or listening to audio programming.

One design goal in the field of Internet music is to make the listening experience as simple as current practice with FM radio and CD's. Because of the limitless and ever changing programming on the internet it is unlikely to ever be an entirely simple process to search and find favorite programming there.

A good starting point is to use an existing installed audio system to play programming from an Internet source. One method for supplying an audio signal to an external acoustic device is to use an FM transmitter that might play the output through a FM radio system. The Sonic Box web site discloses a concept for transmitting to FM radios in a home. AudioRamp shows an Internet audio device to be used as a hard-wired stereo component.

Navigating audio content may also be accomplished by voice commands. An example of this method has been implemented by TellMe networks.

### SUMMARY

It is an object of the present invention to make internet audio programming accessible and familiar to existing users of audio devices. It is a related object of the invention to make Internet audio programming relevant and useful to a new listener without the need for new set-up, search or registration procedures. It is a further object to enable programming from existing FM broadcasters to conveniently lead listeners into personalized Internet programming. It is another object of the invention to present Internet programming that relates to and expands upon real time selected programs. It is another object to integrate music listening with spoken programming. It is a further object to establish a network of providers of programming content that are one or more of: independently owned and operated, linked to non-Internet audio sources, linked to each other, include in common some of a standard program presentation or search format, and are associated with an identifying name comprising a common name element. It is a related object to provide a unifying theme to Internet audio programming while discouraging a single entity from globally influencing that programming.

In one embodiment of the present invention a device identifies audio programming as a listener plays it. Alternate programming from the iternet is made immediately available on a “sidechannel” wherein the alternate programming relates in a specified way to the listener's action. An active selection may be for example a commercially purchased CD or an FM radio station. The Internet sidechannel may include other music selections in the style of the artist on the CD, or a customized playlist created by the FM station. The sidechannel may include one or more programs from sites on the provider network. When a listener selects and plays programs from an Internet audio provider, the sidechannel may present further options related to the selection. According to this version of the invention the sidechannel always has available a branch of selections based on what is being played by a user's listening device. However the number of possible branches should be limited to reduce confusion. The sidechannel playlist may be compiled based on preferences determined by which selections the user has previously skipped or deleted.

A listener of programming according to the invention does not need to actively search for any Internet sites to find relevant Internet programming. Instead the user's ongoing reaction to preassembled playlists form the basis for new preassembled playlists.

However the quantity of choices can be limitless. While a small number of selections are presented at any one time, the presentation of sidechannels may continue indefinitely. Alternately the number of sidechannels may be limited to, for example, just one or two. Such sidechannel limitation would be the norm. In this case a sidechannel's playlist may continue reflect changing preferences, but further channels will not be created.

Although the options need not be limited to programming from the network affiliates, so limiting them will simplify the listening experience. According to the invention, the programming offered by network affiliates is controlled by each operator of an affiliate audio web site. However the affiliates would incorporate a common user experience or interface. The affiliates may also classify their programming according to a standardized system so that searches, such as sidechannel offerings, would be reasonably predictable. When known search methods are applied to the preclassified selections within the network, the process will be most convenient.

Although the affiliates may operate independently, a managing organization or group will ensure that the unified naming method is applied appropriately to describe or classify member content provider sites. The manager will further provide guidance so that affiliate sites conform to a unified classification scheme and user interface.

Affiliates or program providers need not operate by way of a single site or location. An affiliate or station may be a consolidator of information and programming from sites or nodes distributed throughout the Internet or other data network. Or the station or network may enable the user's own equipment to access information distributed throughout the Internet.

The affiliates may be required to have their web sites organized to offer prearranged programming immediately upon a user arriving at the affiliate's home page, or main location. No decisions or options are available upon initial user contact. This is similar to present radio listening. However as discussed above the affiliate's playlist could adjust in response to a user's ongoing actions.

An advantage of the present invention is that existing audio providers can leverage their programming experience to help a listener mold a personal playlist in the course of ordinary listening. For example a conventional FM broadcast station currently finds Internet audio to be possibly threatening. That station can use its long experience with programming combined with the method of the invention to guide existing radio listeners seamlessly into Internet audio.

In one embodiment of the invention, an Internet service provider will act as the agent for the network manager in providing audio service. The service provider may provide the hardware that is used to search and play audio selections. The service provider may further provide billing services in the case that a customer chooses commercial-free subscription service or makes a purchase from an affiliate's web site. In this way a customer registers or sets up the account with the same company that is providing data service. This further simplifies use of the present invention since the customer need not separately buy and configure Internet audio devices.

Two models are known for financing infotainment programming. One is by advertiser support. The other is by subscription service. Combinations of the two may also be used. In one embodiment, a user may be given an option to select in real time which payment method is desired. A monthly bill for service would be calculated according to how much commercial free programming was selected that month, varying between a full subscription rate to entirely free service.

The managing organization may operate a benefit program wherein a listener can receive credits for certain activities while listening to affiliated program sites. The credits may be used toward payment of subscription fees or toward a reduced number of commercials in subsequent programming.

According to the invention a listener can “hit the ground running”. With no computer knowledge or advance decisions required in obtaining devices or programming, varied Internet audio options are passively available to a listener with minimal change in listening habits. importantly, by providing a reason to leave an Internet connected device playing for extended periods, Internet information of a general nature becomes conveniently accessible.

To illustrate use of the design of the invention it is helpful to reference a specific device that is optimized to work with the methods of the invention.

### BRIEF DESCRIPTION OF THE DRAWINGS

FIG. 1 is a schematic representation of a user device for selecting and controlling Internet audio programming.

FIGS. 2 to 16 are exemplary displays and control options as they may occur when using the invention with the device of FIG. 1.

FIG. 17 is a tree diagram showing selection options using the FM band of the invention.

FIG. 18 is a tree diagram showing generic selection options with network affiliate sites.

FIG. 19 is a tree diagram showing search options from CD band.

### DETAILED DESCRIPTION OF THE ILLUSTRATED EMBODIMENT

The method of the invention does not depend on a specific device type or design to be useful. The detailed disclosure is directed to Internet audio, although the method disclosed here would be applicable to broader multimedia programming.

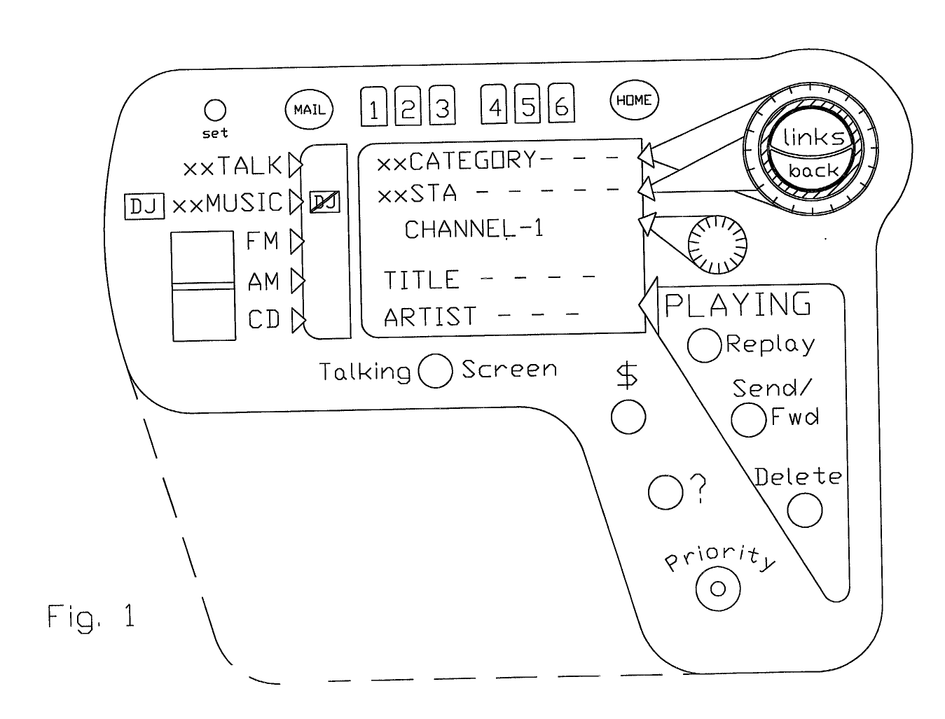

To describe one embodiment of the method of the invention it will be explained in terms of the control device of FIG. 1. The control device may be built into an audio component or it may be a separate wireless unit resembling a remote control. It may control a PC or a specialized Internet server appliance. The server appliance may be wired within a home or office, or the server may be linked to a mobile cellular or satellite radio or fixed wireless system. The same control device may operate different servers, for example in both a user's home and car. The control device may itself be a server. It may be a virtual device on a PC or similar display screen. It may contain, link, or dock to other devices, such as volume controls, keyboards, speech decoders, cellular phones, multimedia displays and other objects or processes that may be useful with the method of the present invention. The dashed line in FIG. 1 indicates a further device or extra features attached to the control device. A server appliance or component that is controlled according to the method of the invention will be called an “audio system”.

In the case that the control device is a virtual device on a PC, various other options and features may be available along with the virtual control device. Using special purpose software a user could set up customized lists of programs and information. These could be downloaded to the user's physical control device, such as in FIG. 1, and associated audio system. However it is a feature of the invention that this type of preconfiguring is not required to begin enjoying personalized Internet audio programming.

If the control device is portable so that it controls more than one audio system then a user's listening preferences and identifying information will likewise be portable. Alternately a user could provide identifying data, such as codes, fingerprints, or eye scans, to different control devices to enable access to personalized programming.

Providers of programming may be associated as affiliates of a network. To make the programming most useful the providers should conform to at least some of a standard format or method of organizing information. This standard will enable a device such as in FIG. 1 to access and arrange programming in a predictable and simple way. The device and method will be particularly designed to work with the network providers, and to efficiently link certain out-of-network providers to the network. For example a CD, FM or AM station can be linked by content to a network affiliate. The link may be by a current program segment or by a more general station format. A certain identifiable song or topic on one of these non-network sources can enable a direct link to a network affiliate that provides related material.

Affiliates may comprise existing broadcast stations including radio and TV, their Internet sites, and other audio Internet operators. These affiliates would dedicate a portion of their Internet operation to conform to the standard network format. They would have a regular business accessible outside the network, such as over-the-air FM radio or Internet audio sites. These “regular” operations would be linked to the provider's network site so that a user could use their network versions with the familiar search and presentation method of the network of the invention. Many providers may choose to have programming from only within the network where all such programming follows the network format.

In the Figures an exemplary standard for using Internet audio is disclosed. The control device of FIG. 1 provides ways to search, select, and modify programming. These options operate similarly for different types of programs and providers. The device includes a display to show type of provider, identity of the provider, and current program. This information can also be presented aloud as speech and, in one embodiment, selected by speaking. The program sources are classified in a standardized way. The left side of the control has a band selector including five “bands”. A rocker switch moves a rectangular indicator to a selected band. The bands include xxTALK, xxMUSIC, FM, CD, and AUX. The xx portion of a name indicates a common component to the Internet site names that network affiliated providers use. Optionally the xx element may be used with names that are owned and operated by the network operator. These names may apply to broad categories, while the affiliates operate within these categories. Then the affiliate need not use the xx name element, but still must conform to the network format standards. Bands according to one embodiment of the present invention indicate a type of input signal or device used to create the signal.

Music and talk are displayed as separate bands rather than at a lower search level since a user typically knows immediately which of the two he is seeking. This simplifies the next level search. However the switch may enable a position between xxMUSIC and xxTALK wherein both are indicated. This allows a user, and certain affiliate stations, to be unspecific about the type programs desired or offered. The resulting searches would be less precise.

The talk and music bands may differ in the type of data signal that serves as a respective source. The music band may require a higher or faster data rate or different data compression methods than the talk band since talk programming is less sensitive to audio fidelity. Thus the talk and music bands may be technically distinct in a manner analogous to low fidelity AM vs. high fidelity FM radio signals. The data service provider can save bandwidth when a user selects xxTALK instead of xxMUSIC. A programming provider using the music band may have to pay more or generate additional revenue to compensate the network operator or data provider for the higher cost of providing the signal.

As discussed later, selecting a link may cause the band to switch automatically. The network format will include advice that an affiliate music site, on the xxMUSIC band, provides an option to reduce or remove DJ and other non-revenue producing talk. The control device shows a button to select on-demand the presence or absence of a DJ. In FIG. 1 the DJ icon in the indicator shows “DJ off”. If a user has selected no-DJ mode, he likely does not want to hear station promotions in a personalized channel either. If a station considers it to be a revenue producing item they may refuse to skip the promotion. However a listener that is using the network by subscription may be especially offended. A compromise can be to show the promotion on the display screen but not announce it. In other bands there is no DJ icon since it is not relevant to talk radio, and would not be an option for non-affiliated broadcast operations.

The AUX band may include increasingly unused AM signal sources as a Category. Other Categories may be tailored for features unique to other input devices or formats such as TV, cell phones, navigation units or other technologies that may be fit for use with the method of the invention. If desired, TV, AM and other signal sources could be distinct bands.

The main display screen in FIG. 1 shows generically “Category” through “Artist”. Artist is specific to music programming. In a preferred embodiment of the invention method, a specific level of search is associated with a specific input device. Further a single device controls the display of information on a consistent part of the display screen. In FIG. 1 the input devices are rotatable dials. Each dial relates to a pointer printed on the control device housing. The pointers indicate which location or line on the screen each dial controls. The large outer dial may be called a “Category” dial. An inner dial is a separately rotatable “Station” dial. These two dials may be called “Search dials”. A single dial below those two is the “Channel” dial. The dials may be color coded to match colors at the arrow end of the printed pointer to further help associate a dial with its screen position. The arrows points are only graphical indicators. Within the inner Station dial are two non-rotating buttons, “Links” and “Back”.

Of course other methods to control and display information may be used. For example the dial functions could be served by up and down buttons. In one extreme one or two buttons would scroll for a search item, while one of the same buttons would select the search level. As more buttons are added and more levels are displayed, up to a point, it is easier to navigate through the selections. In the illustrated embodiment three dials control three respective search levels. The Category and Station dials are nested to simplify the appearance of the device of FIG. 1. The Channel dial is separate since it may be used more often. The dials preferably have a detent action wherein each click when turning represents a step to an adjacent selection. One full rotation of a dial may provide from 20 to 30 steps, but the number of steps per turn would not vary on a specific dial. Or the step increments may jump in proportion to the turning speed, such as a two speed dial action. In this way the stepping action and speed is entirely controlled by the user. It should be noted that there are no dedicated labels on the dials of FIG. 1. The only constraint on the function of the dials is the position of the screen that they control. Even this constraint could be violated if a provider had a strong reason to do so. The intent is to maximize the versatility of the device of FIG. 1 while maintaining a consistent and familiar function for the controls of the device.

The selections could be made with no dials or buttons at all. Rather a touch screen, keyboard or voice recognition could be used to select or enter items in a search level. However a personally entered search subject will be unpredictable in comparison to preloaded items that are dialed in. So a network or affiliate provider would require more sophisticated search capabilities to give useful results to spontaneously entered search items. This becomes analogous to a search performed by a general search engine over the entire Internet. The device and method of the present invention could in fact be used to browse the larger Internet, especially as a voice interactive way of doing so. In fact it is an object of the invention to provide a useful and convenient way to be connected to the Internet. By providing audio programming that invites leaving an associated audio system turned on, other information on the Internet becomes conveniently available through a device used according to the invention. In the immediate disclosure, it is intended to limit the search items to preselected subjects that are most relevant to being served with audio programming.

The Category dial controls the top level subjects. The categories may be the names of sites run by the network operator. Or the categories may describe broadcast station locations or local program sources such as a CD collection. In FIG. 15 the selections for FM band are shown for the “outer dial”. The categories are FM local, FM nation, and FM world. For FM local, the audio system may use the local broadcast signal if it is available. The non-local FM subjects are delivered by Internet. The nation and world categories may be divided into subcategories such as city or nation/city as shown.

After the local or remote city category is selected with the Category dial, the Station dial selects the FM stations that are available there. For local tuning the station dial works the same as using a conventional radio tuner. The device would preferably be designed so that each detent of the Station dial acts to scan to the next good local station signal. For remote cities, the process is also the same, except that only stations that have an Internet feed will be available.

The Channel dial can select different channels within a station if they are available. Ignoring the channel option will leave playing the “Top Channel”. The top channel is the station's main playlist. For non-network stations this may be the only option available wherein the channel dial will do nothing. Other channels and playlists will be available if the station is a network affiliate and has implemented this feature of the network format. Other ways to cause the channel to change are described later.

If the regular or top channel of a network affiliate station has been selected from the FM band, and the channel of that station is changed by any method, a second band indicator will appear at xxMUSIC, or xxTALK, depending on the type of affiliate station or current program playing. This tells the user that the station is an affiliate and that the benefits of such are available. Tuning back to top channel will remove the xxband indicator to show that the playlist is only from station's FM signal. According to a feature of the invention, an affiliate station largely determines how to classify itself within the limitations of the network format template. In this example that means whether the station, or at least the current program, is music or talk. If the station cannot decide whether its program is music or talk its xxband channels may cause both xxband indicators to appear. However the network operator would discourage this practice since it will not normally be necessary, and could complicate subsequent searching. Also as discussed earlier, using the music band may incur a higher cost than using the talk band because of the respective bandwidth needs.

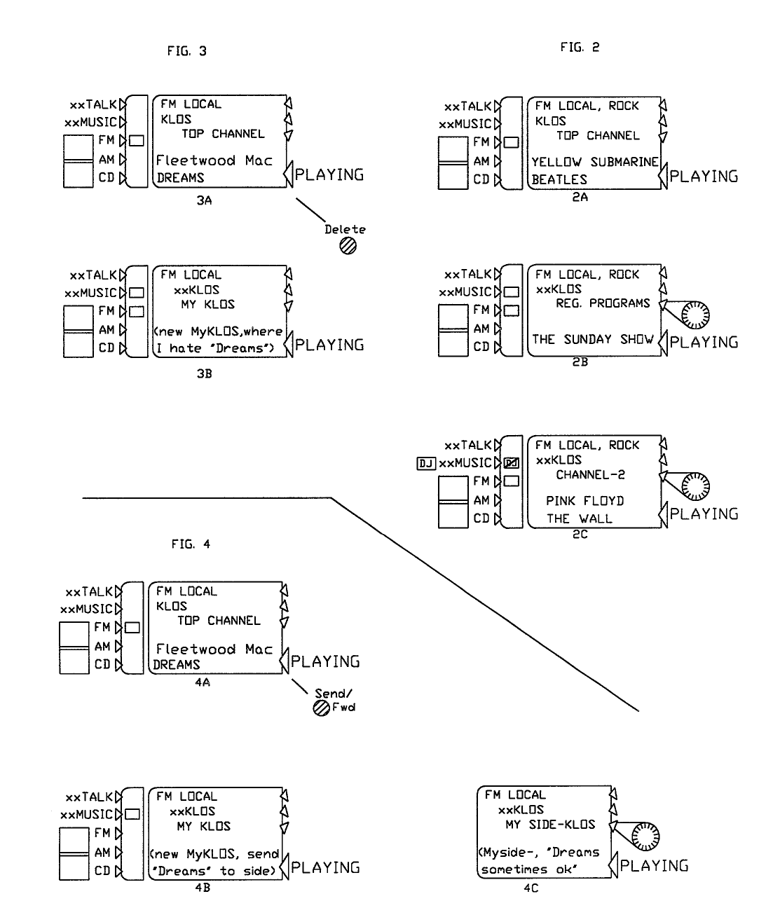

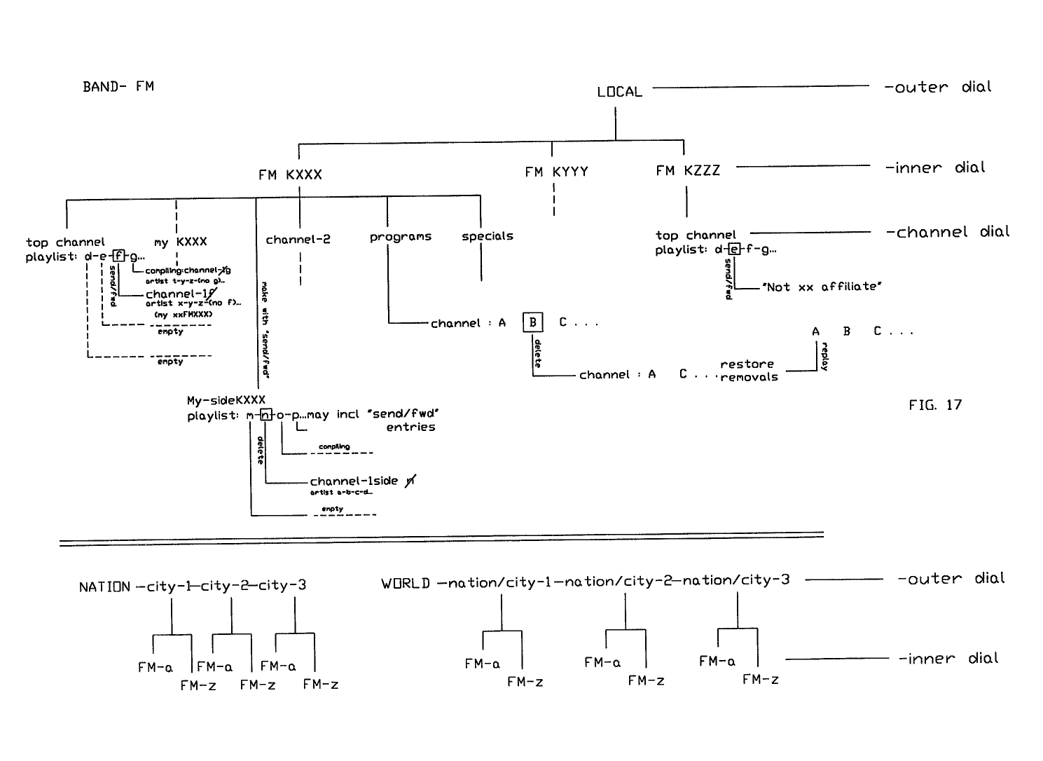

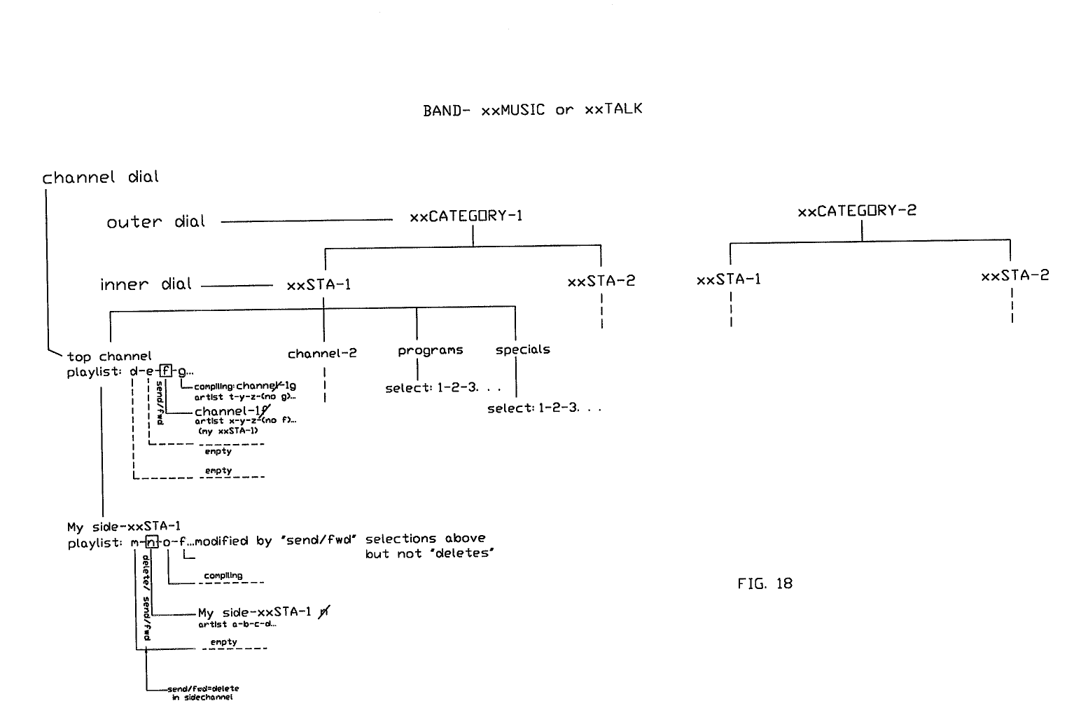

As shown in FIG. 17, the top channel may branch into further channels. FIGS. 2 to 4 show an operational example of extra channels being provided by a hypothetically affiliated FM station. A feature of the invention is to have a playlist modified in real time in response to negative inputs. By acting negatively to selections of a playlist, the playlist can be gradually optimized to best suit the listener. However the user does not need to create a playlist or find any selections actively. This is the concept of “hit the ground running” that was mentioned in the Summary section. It means that a listener can mold a station's playlist while listening is under way. By giving most of the weight to negative input according to the invention, the user need not seek nor pick any program selections. Rather he can merely do what is already natural, which is to avoid the offending selections. But rather than lose a listener by his switching to a competing station, the affiliated station allows the user to delete or move aside the currently unwanted selection.

A new playlist is created before each selection is played on the assumption that the listener does not want the upcoming selection. If the user rejects the current selection the modified playlist is ready to begin. If the current selection is allowed to play through, the just prepared playlist is soon discarded since it is not needed. A subsequent playlist based on rejection of the next selection replaces the previous unused list. In a simplified form of modification the new playlist merely excludes the rejected selection from future play.

FIG. 1 shows proposed “modify controls” that may enable the modifying process. They are three buttons within a printed triangle on the device case. It is proposed that these controls be visually associated with the “Playing” pointer since the three control options act most directly upon what is currently playing. By comparison the dial and band controls described before normally provide a broader search or selecting function. The three options are “Replay, Send/Fwd, Delete”. Replay is used to hear a selection again. It may operate similarly to some answering machines wherein tapping it backs up within the selection while holding it makes the previous selection play. Use of this option could indicate that a user especially likes a selection. But it could also be that he was merely curious about some part of it. Therefore it is proposed that negative input according to the two lower buttons is a more reliable way to construct a user's playlist.

Send/Fwd, when used upon a music playlist, skips the current selection to play the next selection. The removed selection is sent to a sidechannel. The current channel list is modified with the knowledge that the user does not wish that selection to be part of it. As discussed above, the modified playlist may already be prepared in case the selection was removed. However the “Send/fwd” control option differs from “Delete” below it since the removed selection forms the basis for an alternate playlist. The user selects the send option when he sometimes is in the mood for the selection, but not as a common or primary choice. The sidechannel thus created has a playlist that evolves from removed selections to reflect the user's “sometimes” mood. An affiliate station would be advised to include enough variety in a sidechannel so that it does not comprise entirely or even mostly selections removed from the top channel, but is rather “flavored” by these selections. The network operator may provide a system for affiliates to use to assemble these modified playlists using the station's in-house program material. If the listener does not like a selection in the sidechannel list, pressing “Send/Fwd” or “Delete” has the same effect in a preferred method of the invention. This means that the sidechannel is modified by negative input, but further sidechannels are preferably not created. Otherwise endless branching would become unwieldy.

The “Delete” option removes a selection and indicates the listener never wants to hear it. The deleted selection does not form the basis for any playlist. A new modified playlist is started with the next selection. This modified playlist may be as simple as a station's regular list, but without the deleted item in it. Or preferably the new playlist is created in a more sophisticated way based on cumulative negative inputs from a listener to playlist offerings. Such ways may include collaborative filtering or other knowledge based search methods. To maintain an identity a station would not be expected to have playlists to satisfy every listener. Rather, a listener who is deleting many selections from a station would likely choose to turn the dial to another station, or to another category.

If desired “Delete” could also enable removal of an entire modified channel so that it can be created anew. This may be useful if a channel has evolved in a less preferred way or if the user just wants change. For example, if the button is held for a long time while tuned to a sidechannel, the display or audio system will prompt the user “If you want to remove this channel press delete again”.

The playlist creation just described is shown in FIG. 17. FM band is selected and FM station KXXX Top Channel starts playing. The user does not want to hear selection “f” right now and presses “Send/Fwd”. As described earlier, if the station is not an affiliate nothing will change and the Top Channel will continue to play unmodified. If KXXX is a network affiliate a new playlist “x-y-z...” has been already prepared in case “f” was removed. The next selection is the first of this new playlist. The new channel is called “My-xxKXXX”, and the xxMUSIC band indicator shows as described before since the modified channel is a feature of the xxRadioNetwork. My-xxKXXX channel is now playing. It can be modified continuously as the listener removes selections.

In the meantime a sidechannel “My-sidexxKXXX” has been assembled, using the Sent selections from the higher channels as a guide. However note that selection “f” is not included in the example sidechannel playlist of FIG. 17. The intent of the invention method is that an affiliate will use a Sent selection as the basis for a “sometimes” playlist. That does not mean that “f” must actually be included in the list, but merely that it serves as a guide in creating the list.

Normally a live DJ would be available only on the Top Channel, since it could be costly and difficult to provide one on the lower virtual channels. However if a DJ is desired on the lower channels a combination of prerecorded, synthesized, and live feeds may be provided.

The affiliate station may offer more that one playlist type channel, shown as channel 2 in FIG. 17. A broadcast FM station would normally not have this option except by Internet delivery. An Internet station could offer such multiple channels on an Internet site. But the exemplary device of FIG. 1 and the playlist modification methods would not function on the station's site unless it were using the methods of the invention.

A network station will be advised to offer some additional channels. In FIG. 17 these are “Programs” and “Specials”. The Program channel lists regular shows that the station offers. Such shows usually have a title or descriptive name. For example a show might be called “Space Tunes” wherein an hour of mood and electronic music is played every Tuesday night at 8PM. Or it may be a talk show that airs every night. A particular program can be selected within the program channel. The affiliate station may choose to offer shows from the past week, or past month, or other option they consider reasonable. They may charge the user a fee to hear programs from long ago, where old programs may be stored in less accessible ways. Paying for archived material is common practice, for example, in newspaper web site services.

In FIG. 17 the Channel dial works to select the program titles. So moving the channel within “programs” will play a specific program. Pressing and holding the replay or send/fwd buttons will advance or move back within a program episode. Tapping the buttons will move to the previous or next episode of a program. Of course most providers will not offer future episodes. If a user returns to an episode that was recently playing, it may be desirable that he is returned to his previous location within that episode. Another tap of the button would move back to the start of the current episode or forward to the start of the next episode. The modify buttons do not select other titles; this function is by the channel dial.

Programs titles that are not desired can be removed from program channel. Pressing delete will remove a selected title, possibly after a warning. In the example of FIG. 17 program “B” has been removed from the list. At the end of the list an option to restore the removals is available. In this “restore channel” the user is prompted to press “replay” to undo the remove actions. The original playlist, similar to a Top channel of regular programs, is restored. The user may be allowed to selectively restore specific programs by turning the channel dial to highlight selections that have been deleted, and being prompted to press replay at the highlighted item. Since creating a list of preferred programs from those offered by a station is straightforward, it is not likely helpful to provide a sidechannel of “sometimes desired” items. In this regard, programs are treated differently from music playlists. The “send/fwd” button does not send a program title to another list. However a station may desire to enable some other type of send finction for regular programs. Specials will not likely have a customizable list since by definition they are irregular events. Instead the channel dial will just allow choosing of titles. The affiliate station will decide how many specials to list and how long to leave them on the list.

The Channel dial can be used to select the various channel options discussed above. These may include Top Channel, Channel 2, My KXXX, My-SideKXXX, specific programs, and Specials. The station operator may wish to add more channel options, but would be advised by the network operator to design such offerings carefully to prevent confusing or inconsistent channel types.

Within a particular station a user may be seeking past shows of only music, or just past talk shows. While a default may allow both talk and music types to appear, the station may designate each show as one or the other. Then an option could be made to force only one or the other by actively selecting either xxMUSIC or xxTALK in the band selector. Normally a station would not be expected to offer programming in advance of its play on the Top Channel, but of course they may choose to do so.

A further channel option is “Specials”. As the name suggests these are programs that are not periodic or regular. But they can be listed in similar ways to the regular programs.

Of course many variations on the use of the controls of the device of FIG. 1 are possible, as determined by the station and allowed by the network operator. Also many variations on the design of the device of FIG. 1 are possible, including the particular control options.

In FIG. 17, the Top Channel for station KZZZ is shown. But this station is not a network affiliate. So pressing any of the modify controls will not affect the play. A message may be displayed or announced that the station is “not an xx affiliate”. Or if the station is an affiliate but does not have that particular option available a notice may say “This option not available on this affiliate”. However the ability to modify at least one playlist channel may be a prerequisite for being a network music affiliate.

FIG. 18 shows a similar concept to the FM stations of FIG. 17, except that FIG. 18 is general for all affiliate program providers. If these sites are accessed by the Category or Station dials, the search may be limited to affiliate sites only. But links to non-affiliate sites will be possible. Note in the example for xxSTA-1 in FIG. 18, the removed selection “f” has been included in the sidechannel playlist. Although the example of FIG. 17 did not incorporate the removed selection, it would likely be common to include the item.

It is a feature of the invention that program providers who wish to use the method of the invention are free to interpret how to use it. In the example above, one station chose to use a removed selection as a basis for assembling a playlist, but did not include the item. The other station included it. This demonstrates a broader concept. The present invention provides a way to link, search for, and modify programming and information. However each affiliated Internet site or station that uses the method retains control over the programming that is offered. If a user listens to two similar music stations with similar playlists, removing the same selections from each may result in quite distinct playlists. This is because the affiliates can interpret the negative user input in different ways within the method of the invention.

The network operator may provide each affiliate with software routines and systems for creating modified playlists and other elements of the invention. These systems will preferably be designed to be flexible in how they are applied so each affiliate can use their own programming philosophy to help a listener modify a playlist.

FIGS. 2 to 4 shows specific displays that may appear when listening to an affiliated FM station. The category dial has been turned to FM LOCAL. The station dial has selected a local FM station KLOS. The term “Rock” may appear in the Category or Station line if KLOS has elected to provide that information, as in FIG. 2. Such an identifier would be especially helpful when searching nonlocal radio stations. The channel dial has not been moved so the Top Channel is playing. However if the user has listened to this station before and had the channel set other than Top Channel it would preferably start in the channel where it had last been. The programming is from the station's standard signal, where the Beatles' Yellow Submarine is currently playing in FIG. 2A. In FIG. 2B the user has turned the channel to “Regular Programs”. Since the station is an affiliate this option is available. The band indicator adds xxMUSIC since the show selected is a music show and is a feature from of the network. FM band remains indicated to show that the station has a conventional FM operation.

The most recent “Sunday Show” episode starts playing in FIG. 2B. Of course it need not be Sunday to hear this show on this Program channel. Pressing and holding “send/fwd” will advance within this episode of “Sunday Show”. Tapping Send/fwd will not do anything since KLOS does not provide future episodes. But tapping Replay will access the previous episode, maybe from two Sundays ago. Holding replay will move the play toward the beginning of the current episode.

Turning the channel dial further to the right will select a different show. If KLOS declares it a talk show the xxTALK band is indicated. If the type is music or not specified the band will remain at xxMUSIC as this is the main format of KLOS's Top channel. If neither the current show nor KLOS's main format is specified or is indeterminate then both xxbands will be indicated. Affiliates will be encouraged to specify a main type format as well as any differing programs. For almost any station or program this identity will not be vague. A show with minimal music and much talk about music would normally still be a music show, especially if a music format station is playing it. But such a show on a talk radio station would be a talk show. This distinction is useful since it helps focus a listener's subsequent searches and links from a site, and also may affect the type of data signal that is needed or provided.

Returning to FIG. 2, the display in FIG. 2C shows channel 2 playing. KLOS offers this additional music channel. Channel 2 is playing a particular music selection. This channel is to the left of the Program channels, in the respective position shown in FIG. 17. Here the DJ button has been pressed to remove DJ talk from the playlist. The modification techniques described above for the Top channel would be expected to work on this channel as well.

In FIG. 3 the creation of a personally modified channel is shown. A listener dislikes the currently playing song “Dreams”. Pressing “delete” moves the playlist from the Top channel to the new list “My KLOS”. The xxMUSIC band is added to show the new playlist is a feature of the network, and that the Top channel is no longer in use. The new “My KLOS” channel playlist is assembled by KLOS with the knowledge that the user never wants to hear “Dreams”.

In FIG. 4 the user likes to hear “Dreams” occasionally, but not as a prime choice. Pressing “Send/fwd” removes it from the newly created “My KLOS” as above, but a KLOS designed playlist is assembled knowing that the user occasionally likes “Dreams”. “My KLOS” will be playing, while the additional “Sidechannel” based on an occasional liking of “Dreams” is ready and accessible with the channel dial as in FIG. 4C. As discussed earlier the sidechannel playlist need not actually contain “Dreams”, but it is designed with the knowledge that that listener likes it occasionally in the context of the KLOS format. As discussed earlier the Send/fwd action upon the sidechannel will have the same effect as Delete, since it is normally not desired to create further sidechannels. But a station may offer unlimited sidechannel branches, where “send/fwd” creates ever more lower channels, if they feel their listeners will like it. As the “Send/fwd” and “Delete” actions continue KLOS has increasingly more information to use in personalizing a user's playlists.

According to the invention a station can customize a user's listening experience within the confines of that station's overall format. But a station can leverage its format into unique, or at least more distinct, subformats suited to each listener. Rather than create entirely unique playlists for each listener, a station may design a number of preassembled playlist types and assign one of these to respond to a rejection of a selection within a preceding playlist. Limiting the possible variations may reduce the complexity of assembling “MY-channels” or “Sidechannels”. The network operator can provide the stations with tools to design the customized playlists using a station's own library and market intentions.

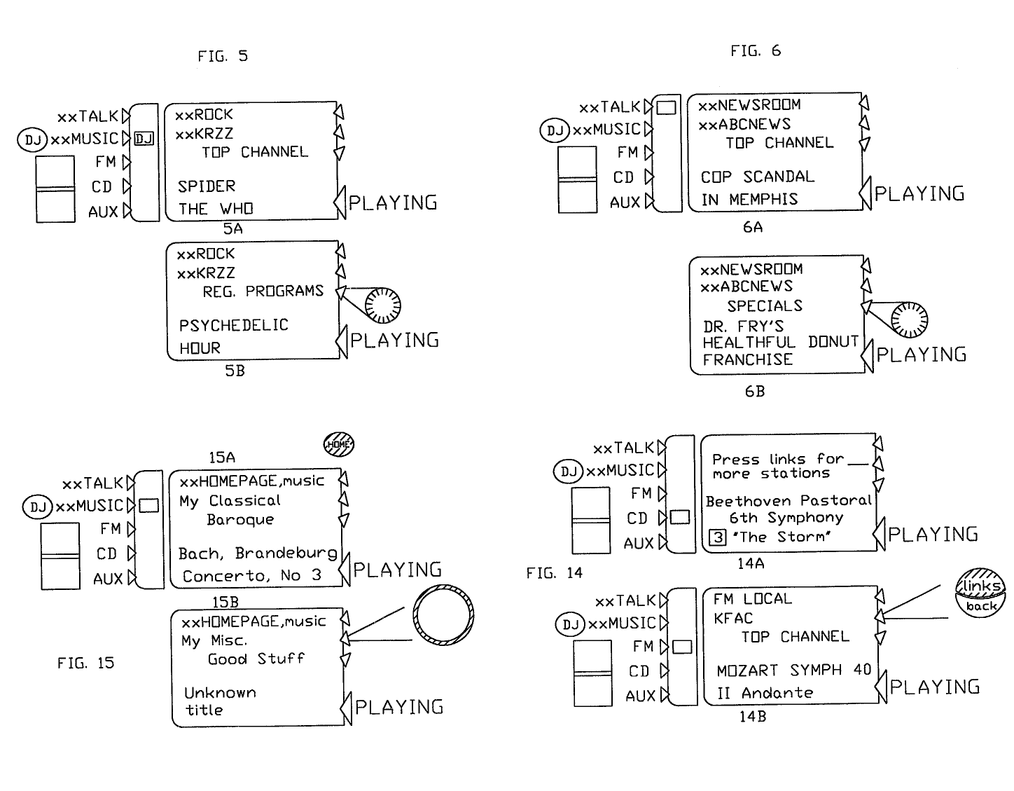

In FIG. 5 an Internet only station “xxKRZZ” is shown. The xx indicates KRZZ is an affiliate. This station relates to the xx network diagram of FIG. 18, where FM band is not involved. It may be possible to access non-network Internet stations with the two Search dials, but the network standard Channel dial navigation and Modify options will not likely work. If the station is not an affiliate the xx will not appear before the name. In FIG. 5 the category Rock was selected with the outer dial, station xxKRZZ with the inner dial, and the Top channel is playing “Spider” by “The Who”. The DJ button has selected to hear a DJ. Since xxKRZZ is an affiliate Internet-only station, the Top channel may offer the option of no DJ since an Internet only signal has fewer format constraints than an FM broadcast Top Channel signal. Therefore pressing “no DJ” would not send a user to My-KRZZ channel unless the playlist is further modified by removing a selection. As in the examples of FM KLOS, the same type of modify and selection options are available.

FIG. 6 shows a station that is found on the xxTALK band. In FIG. 6A, ABC News has an affiliate operation in the xx network, linked from xxNEWSROOM. The Top Channel may comprise a standard feed from ABC's network. ABC may have separate station operations focused on local, national, and world news. Then the station dial may choose between them. Or a single station provides three Top channels focused on one of local, national, and world news. Since ABC news is a large organization with deep resources, they would be able to fill each of these subjects with much material to navigate. Therefore separate xxABC stations would be encouraged by the network operator. A smaller or more focused news operation may be less welcome to have three stations at the Station dial level.

Each station normally represents a distinct Internet site or equivalent entity. Although it is not shown in FIG. 6A, the “Links” button of FIG. 1 may be useful in the ABC site. Either the network operator or ABC news decides where a link goes to. In the case of FIG. 6A, a link may go to other ABC police stories, or maybe more typically to more in depth stories about the Memphis cop scandal. ABC may decide that pressing “Links” causes the creation of a new channel for the listener on this ABC station, where the channel has only stories about the Memphis cops. In this example “Links” is used as an indication of positive feedback. An information station may especially want to make a single subject channel for the user if there are extensive information and stories on a subject and if the user's Modify actions have indicated less interest in other stories.

With regard to Modify, the list of news stories may be treated in the same manner as a music playlist. As with music this is a highly effective way to customize news stories. If a story is not at all interesting the user can press Delete. The channel then switches to “My ABC News”, and that story subject will not be presented again. The news provider will assemble the user's list of stories with the knowledge of which stories were not wanted. The Send/fwd button will remove a story from “My ABC News” and place it in the sidechannel. If the listener is in the Top Channel the Send/fwd action will change the channel to My ABC News as the forwarded story is sent to the sidechannel. This modification method is very similar to that for music, so a user will find it familiar in either environment. Updates to sidechannel stories will stay in the sidechannel, where the stories are of medium interest to the user. The user can always turn the channel dial to Top Channel if he wants the news provider's main story list. The news provider will decide how to use the listener's negative input as story lists are assembled. Special methods and tools for doing so may be supplied by the network provider.

Returning to FIG. 6, in 6B the channel dial has been turned to “Specials” of the current station. The current item is a one time story, or series, on a new type of donut. As discussed earlier, the Send/fwd option may not create a sidechannel since specials may not lend to preassembled content. But either of the send/fwd or delete buttons will move the play to the next story. The station may decide that the Delete option removes the offending story from the specials list so that it will not be available on replay of listed items. A method to restore deletes is described earlier for music program shows. However a story may be played as a priority if the news station or any other provider assigns that option to a selection or channel. The “Priority” button in FIG. 1 enables this option. It is discussed in detail later. In any case the list of available Specials will change as the station removes old ones and adds new ones. The station may provide ways for a user to operate the control device to access archived stories or specials. This may be an added cost service.

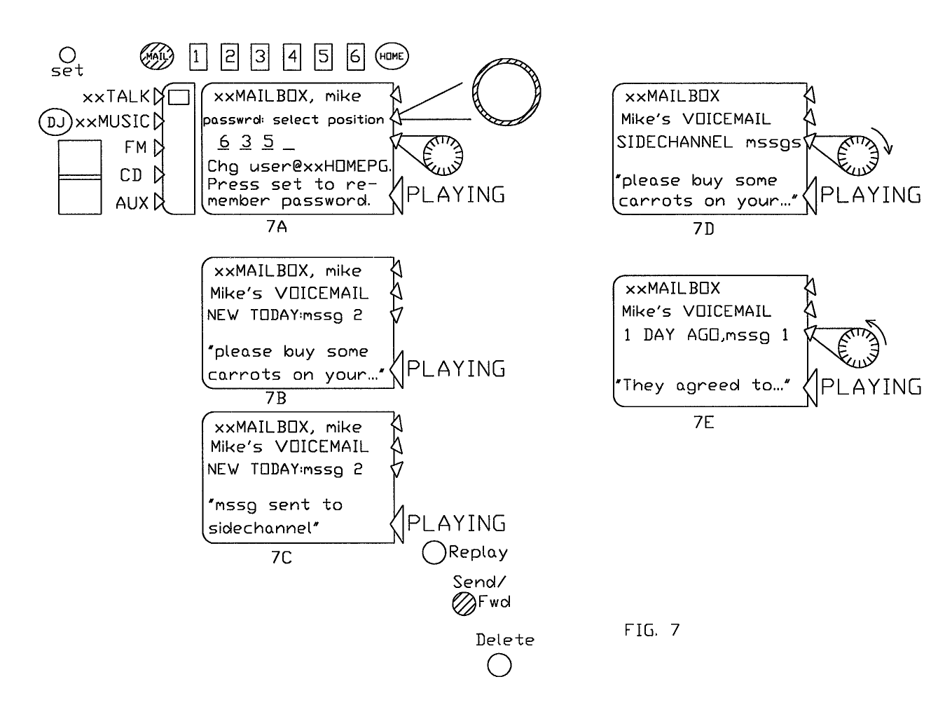

FIGS. 7 to 13 demonstrate use of the method of the invention for purposes very different from broadcast audio programming. For a device that has multiple users there should be a way to select the current user. This may comprise one of the options at the category of “xxHOMEPAGE”. In this case the Station dial accesses a station option “Identity” and the channel dial selects the user from preloaded options. Theses options may have been installed from a PC. The user identity may be selectable at more than one category, by a dedicated control element of the control device or by a remote data input. xxHOMEPAGE will be on both talk and music bands since a user may wish to store these distinct types of material in the homepage. The band selector would select between the music and talk home pages.

In FIG. 1 the exemplary device shows six generic preset buttons and single purpose “Mail” and “Home” buttons. These will take a user to respective xxMailbox and xxHomepage categories. The numbered presets may enable direct access to preferred stations. Preferably they send a user to a specific station, and to the channel that had been last selected in that station. The six presets shown could provide 12 presets using a double-click option. For example double-clicking on preset 2 will select a preset named “2A” or “2+”, where the 2 or 2A is indicated on the display. Of course there could be more options such as “23”, but this is much less convenient to input. The “set” button is used in a conventional way to assign a preset button to a station. Each band therefore has at least 12 preset options. For CD and AUX the function of the presets may be decided by the device manufacturer or others.

The music xxHomepage would be optimized for storing personal music selections or collections that are not available or not convenient on an outside station's own playlist. In this case a user would likely set up playlists or collections using his PC. The network provider would offer software tools to help the user compile customized playlists. The user can then download the lists and selections to the user's own xxHomepage for use with an audio system according to the invention. These custom playlist may be from a user's own CD collection, MP3 files from the Internet or other sources.

In FIG. 15 a display of custom music selections on xxHomepage are shown. On his PC the user has arranged the playlists into self-named “stations” that play different music styles. The station in FIG. 15A is classical. The channel dial selects type of classical. In FIG. 15B, the user has created a station on his PC for things he cannot or chooses not to classify. Likewise the channel is nonspecific. But this channel no doubt has meaning to the individual who created it, in the manner of an untitled cassette tape of enjoyable radio tunes that people made in the '70s. In fact a user could download his old cassette collection into a “Cassettes” station, with channels named by the type of tape (Maxell, TDK), box they were in (Red shoebox), or year they were made. The selecting method of the invention helps a user to organize seemingly random collections.

In describing the PC as a the way to download playlists, the term is used generically. The device of FIG. 1, or an accessory linked to it, could enable the collecting and downloading of selections into a user's xxHomepage. But a PC may be the easiest way to arrange and name very customized lists, especially if appropriate software tools are available.

Pressing xxTALK band would lead to ‘xxHomepage, talk’, with Talk band indicated. This category could be arranged like the music one, with stations and channel names selected by the user from his PC. Shows found elsewhere on the network, mailbox messages, personal recordings, could be downloaded and stored here. If the user wants easy access to a specific radio show, similar to keeping a recording of it, xxHomepage Talk, would be a secure place to keep it since it would store it away from where it originated. If the originating station removes it, it is still available to the user. As above selecting and adding material to custom named xxHomepage stations would likely be easiest on a PC with good software tools. The user would provide the material from outside sources, or locate desired materials in a Channel, MyChannel, or sidechannel, as the desired item is being heard over the audio system.

xxHOMEPAGE may also list the various Stations for which any Mychannels or side channels have been created in the course of listening to affiliate or other stations. This becomes a shortcut to these playlists. “Links” would take the user to the hosting station's main operation and Category. These personalized channels can include non-music related product listings as discussed later, or other search results that were generated on the xxTalk band. “Back” would take the user back to the xxHOMEPAGE.

Alternately categories could be offered that could be used as surrogate presets. These could be “xxMyChannel” and “xxsidechannel”. Within this category the Station dial would tune to stations for which a My- or side channels exists. It is a shortcut to previously listened stations without a need to know or find the specific category the station was in. This would work only for stations where the playlist had previously been modified in some way. As with the Homepage category above the contents of these two categories would have only stations that the listener had found interesting enough to modify at some point. Station Delete options would of course be available within “xxMychannel” and “xxsidechannel”. The “Links” button in FIG. 1 would not change the user's channel or station in this situation, but it would move the play to the station's assigned Category and provide access to the station's Top Channel. In FIG. 1 the “back” button would return the user to “xxMychannel” or “xxsidechannel” category so that further modified lists are easy to find.

In FIG. 7 a mailbox system is shown. It is found in xxMailbox category on the xxTALK band. The current user's name shows next to the mailbox category. The user of the control device must be known to ensure the correct messages are accessed. The user also will want the modified channel playlists that reflect his preferences. It may be desired to require a password. However any password need not be very high security since the control device would also defme account access privilege and user ID. Possession of the device in a user's home, car, office or virtual PC version comprises part of the security system. Of course payment systems that may be used as part of the invention may require additional security protection.

In FIG. 7A a password entering process is shown. The Station dial selects the numeral position, while the channel dial selects the number. This code entering method may apply to other security or number related activities in addition to email. An option to store the password is shown. Today's messages are being played in FIG. 7B. In 7C today's 2^{nd} message is being stored. In 7D turning the channel dial plays the messages stored in the sidechannel. Pressing send/fwd in the side channel would not have an effect but delete would. Holding delete will clear the stored messages after a confirming prompt. Turning the channel dial the other way accesses older messages in FIG. 7E. Send/fwd would save these older messages in the main sidechannel, or a further sidechannel.

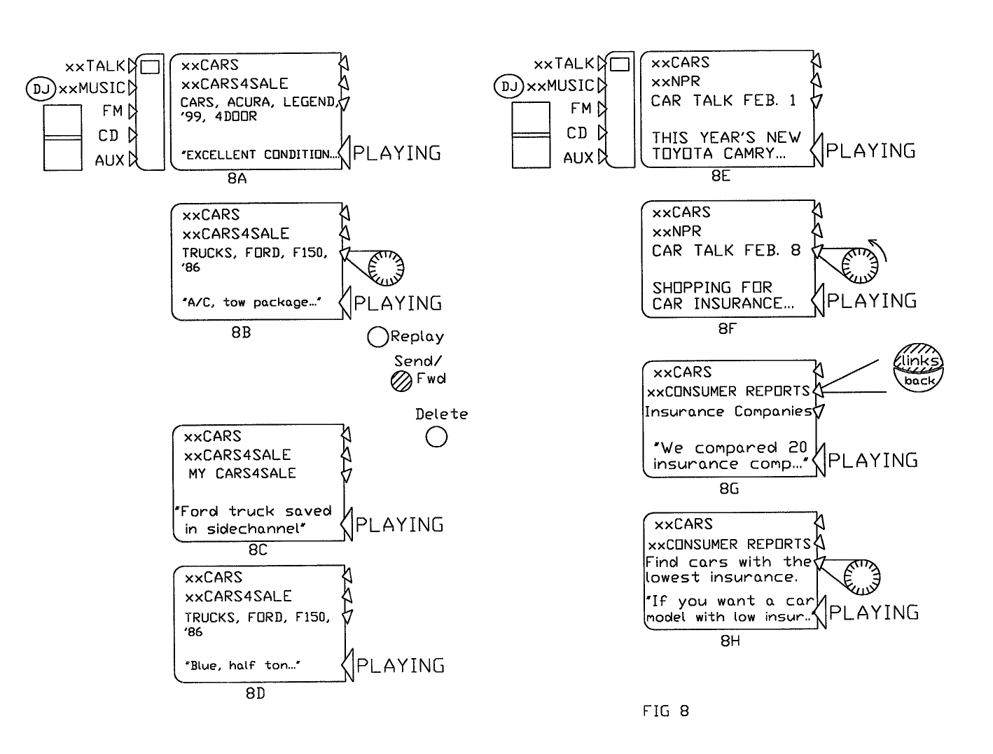

In FIG. 8 the “Cars” category is shown. The method of the invention is used for searching for cars for sale and for finding and listening to car related radio shows. In FIG. 8A the station “Cars4Sale” has been selected with the station dial. A classified ad company operates this Internet site. They have set up the listings to allow the channel dial to select a certain level of detail. Within the criteria of “Acura...4door”, the car listings are playing. The user wants a Ford truck, so in FIG. 8B the '86 Ford F150's have been dialed in. The user likes the “tow package” truck so he presses Send/fwd. FIG. 8C confirms the save. The Ford F150 channel continues playing. Unlike for music, the channel does not automatically switch to the saved list in the sidechannel since this would not be useful for a search process. The “Top channel” is the company's ad listings, but identifying it as such would be redundant here. Turning the channel accesses the saved trucks. The site operator may chose to provide a side channel at the end of each section, such as Cars, Trucks, RV's Vans etc. so the dial need not be turned all the way to the end of the whole list to access the interesting vehicles. A master saved list could be at the end of the channel listings. The operator may further provide the contact information, such as telephone or other seller ID, only for the saved cars so that the main ad playlist is no longer than necessary.

In FIG. 8E-H, programs and information about cars are shown. NPR radio has an xx affiliate site with a car show. In the xxCARS category an NPR station will show up. The network operator provides a search function that places NPR in this category because NPR has a program about or related to cars. This demonstrates that one station or site operation can appear under more than one category if it has features or functions that fit in multiple categories. Turning the channel back would go to earlier Car Talk shows. Pressing links could take a user to NPR's main site, or as shown in FIG. 8G, it could go to a different operator's site for another car insurance related program.

A content link is sensible if the current Category clearly suggests it. If a site operator wants to ensure that a link to their main site is available regardless of the network's link criteria, the operator provides another link by the channel dial. Turning to a certain position will present a channel that displays a suggestion to press “Links” to go to the operator's main site, in this case NPR's main site. These “Main Links” channels could appear at regular intervals as the channel is turned. These special channels are called “Channel Inserts”. In general an available link may be different depending on which channel is selected. A link option would normally also vary with the station and category.

The special item insertion on a dial could apply to advertising also. The network provider can include Category Inserts along the top level Category dial, where the income from such ads goes mostly to the network operator. Ad income from insertions on the “Station” dial may split evenly between the network operator and station site owners. Ads by Channel Inserts would mostly benefit the station operator. This income scheme reflects the entity that controls the level at which the ad appeared. A network ad would include the usual station and channel options to listen to its contents. A user navigating through the ad would indicate user attention, this being equivalent to “click throughs” in the visual Internet. This causes enhanced payments from the advertiser; mainly benefiting of the group controlling the level it appeared. Station operators may also benefit from inserting their own station promotions or cross promotions into these Channel Inserts. The Inserts would typically vary in frequency, content and location on a dial, possibly in response to a user's account status, searching or listening habits. For example a Channel Insert may provide one time information to a user, available if he chooses to turn to or through it. The channel could be gone the next day. Channel inserts are encountered when scanning or selecting with the search or channel dials. Using Links, presets or other direct access methods would normally bypass them. But a station could force a user to initially land on a Channel Insert from a direct access action for promotional or other reasons.

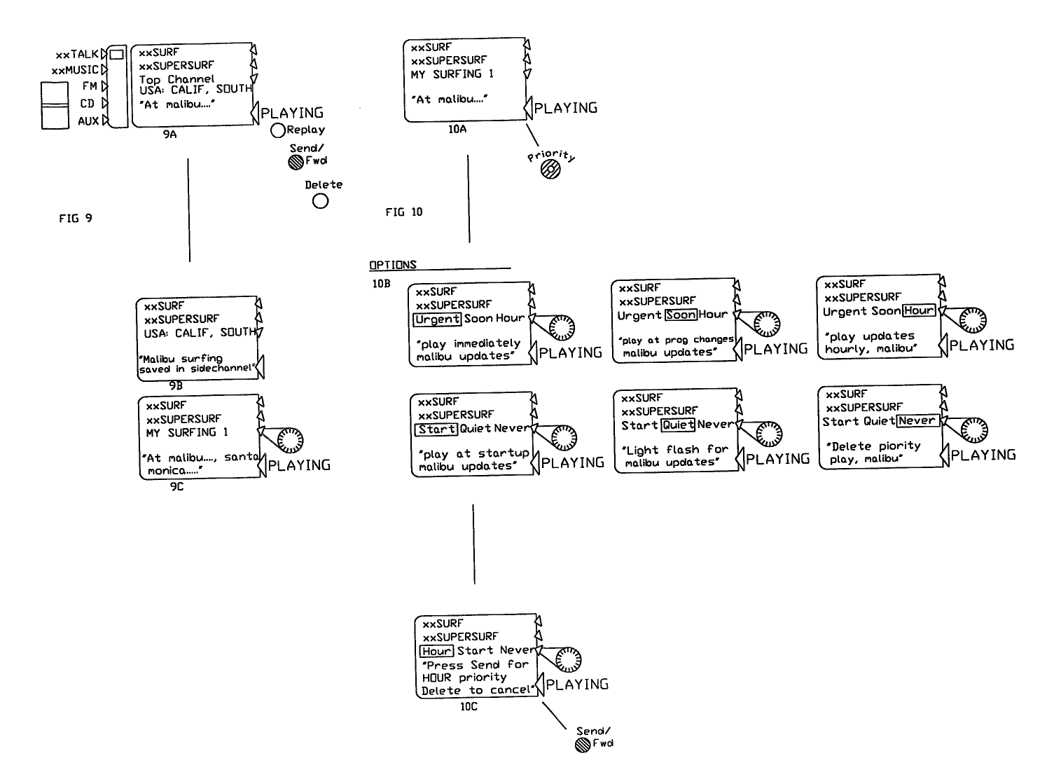

FIG. 9 shows a way to find surfing condition reports in an example of a focused interest use of the invention. The station operator “Supersurf” provides surf conditions. They have divided the channel search function into north and south California. Conditions at various Southern California surf beaches and monitoring locations are played. In FIG. 9A Send/fwd saves Malibu conditions in the sidechannel. Supersurf may offer two levels of conditions whereby pressing Send/fwd upon a selection in the first side channel moves it further to a second one “My Surfing 2”. These sidechannels become the user's personal surfing playlist. Any selection can be deleted from a sidechannel, but the Top channel would not normally allow deletions.

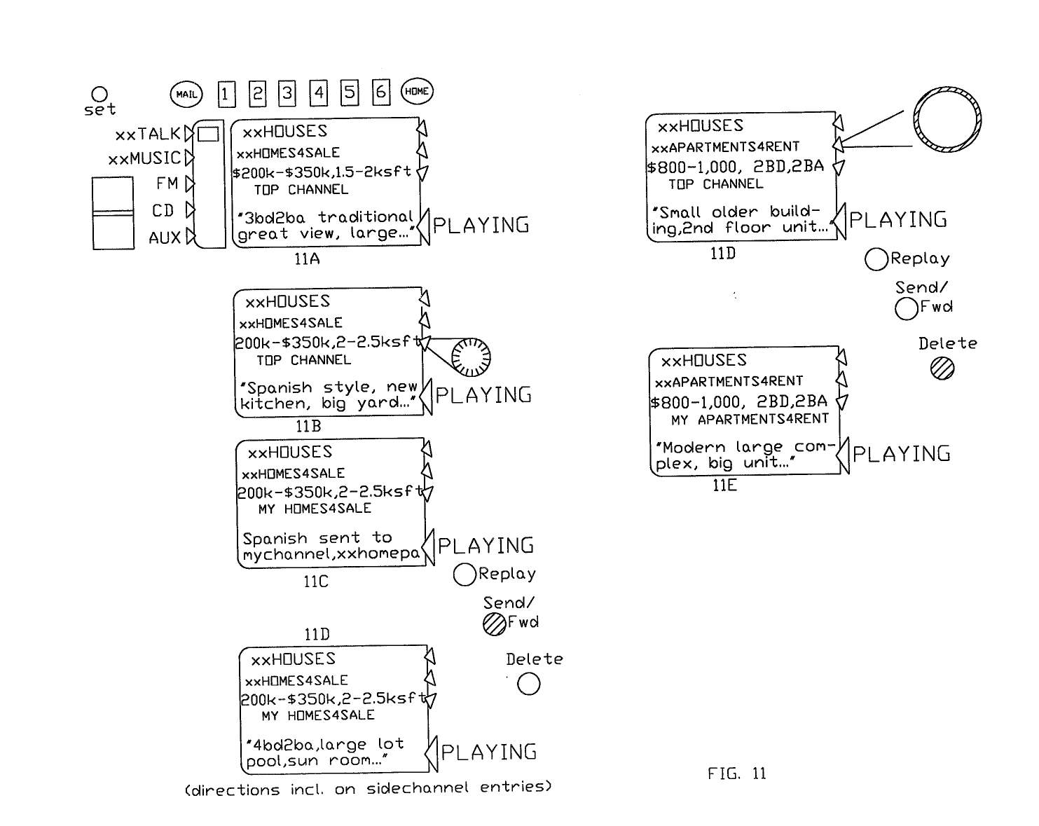

FIG. 10 shows an application of the “Priority” function of the invention. The Priority button is seen in FIG. 1. The listener wants to be informed about surfing conditions at Malibu on some type of priority basis. As Malibu conditions are playing he pushes “Priority”. The Supersurf station has opted to make some type of priority update available. If the station provides no such option the user is informed “Priority play is not available on this station”. Six priority options are shown in FIG. 1OB: urgent, soon, hour, start, quiet, and never. Urgent will interrupt play as soon as a Malibu update is available. Supersurf may choose to provide updates that meet only certain criteria, such as significant changes in conditions or especially good waves. They may tell the user the update criteria they use for the current selection. These criteria could be customized, most easily by visiting the station's web site on a PC. Or a regular channel or Channel Insert may offer customizing. “Soon” will usually play between program segments, such as between songs on a music station. Hour will be on the hour. Start will be when the listener turns on the audio device or control device. Quiet will be by flashing a light only, within or near the priority button, likely in the Urgent time frame. Pressing Send/fwd selects the “Hour” option in FIG. 10C. Delete cancels the priority activity.

“Never” will cancel a priority request. If an unwanted priority item interrupts, pressing priority as it plays will bring up the priority options, in the same manner as if it were playing as a regular non-priority item. A difference is that the Never option is the default when pressing Priority for a previously selected priority item that is playing. Pressing delete or send will remove the item from the priority playlist. Delete will work only with the never option, since send/fwd is the consistent option but Delete is the intuitive action when reacting to something unwanted.

Another way to access the priority playlist is to double-click the Priority button. This links to an xx Priority Category or a Priority Station on xxHomepage. This is a way to prompt on demand any waiting updates. The last selected Priority will play, and the playlist will continue for items that have met a priority update criteria. Within the Category or Station, priority items can be accessed and deleted as above. Pressing “Back” under Links or changing the Category or Station dial will stop the priority playlist.

Many stations will play items that can be prioritized. Traffic is especially obvious. A traffic station would have an ordinary Top Channel with typical traffic reports. The station may offer another channel dial option of “This Location”. Traffic is reported for conditions ahead. A driver could press Priority while listening to this channel. In the future when passing this location an urgent priority of conditions ahead of this location would play if any update criteria are called for. The traffic station can make a sidechannel called “My drive” where all these priority locations are stored and can be played at any time. A user may do this on more than one traffic station at the xxTraffic category if he wants to hear different reports of the same area. My Drive channels are also available at xxHOMEPAGE.

The traffic examples assume a mobile Internet data provider, wherein the user's location is knowable by the data provider. Then the playlist from My Drive channel can be adjusted to play locations moving away from a current location first. With any location sensitive programming the data service provider must know the location of the user, or the user must provide that information. Even with a fixed service such as cable or DSL the user's location can be known so that home or office searches that are location sensitive may benefit. For mobile use it would be recommended that the information be stated aloud rather than just on a display so that a driver need not read anything. A user can also preload locations of interest form a PC.

Another button is shown in FIG. 1 labeled ($). This feature is provided for use by station operators for use as they see fit. It may be used to link a program to a related selling service, check or compare prices of items, check user account status, such as commercial free playtime that the user has earned by responding to ads or surveys, sending or receiving money through devices operating in the AUX band, or any other features and options that may be determined by the program providers. In this regard the ($) button is similar to the * and # key that was placed on early touch tone phones before clear uses for them were apparent.

Regarding stating the information aloud, a button on the control device of FIG. 1 is labeled “Talking Screen”. This enables the information on the screen to be spoken to the listener. Such device usage or program descriptive information is distinct from programming content which, in an audio device, is audible by design. The reverse is also true; that some of the audio programming content can be displayed visually. Especially for specific information such as car ad descriptions or telephone numbers, having the playlist contents displayed in writing may be helpful.

In FIG. 11 a real-estate oriented Category is shown. FIG. 11A has a station “Homes4sale” selected. The operation of the search is much the same as the car ad station of FIG. 8. The channel dial selects homes by price and size. In FIG. 11C sending the Spanish style house to the sidechannel moves the play to the sidechannel. Here the station may edit the list to reflect the user's positive and negative actions. Or the station may leave the play in the top channel and not attempt to personalized the list.

This station is set up for mobile users whereby the user's location is known and homes nearby are listed. An additional channel may offer options to select other areas by, for example, dialing in a zip code using the method shown for mailbox passwords or a voice prompt. Likewise the user may preselect areas or homes from a PC to include in a sidechannel. As with the car site, the saved homes have additional details, such as the selling agent's telephone, and maybe directions to the home. In FIGS. 11D and E, the delete button is used to skip to the next apartment listing without saving the current one playing.

It can be seen that the features of the control device may vary slightly in function depending on the station that is selected. If a user is not familiar with how to operate a station's features the (?) button is available. Pressing (?) will start a playlist of general features and options available at the current station. Pressing (?) and the control option that is under question will start playing the options available for that control option at the current station. In the above real-estate station example pressing (?) and turning the Channel dial in any way may provide an explanation: “Turn the channel dial to select homes by price and size. Turn it all the way left to the Location Channel for other areas. Follow instructions to enter desired zip code. Press replay to hear again, delete to stop this message”. The network operator would require that affiliate stations adhere to certain guidelines so that the experience of using different stations on the network remains consistent and familiar. So music stations would fit one pattern, things for sale another, etc. But even between different types of stations the user experience remains substantially consistent.

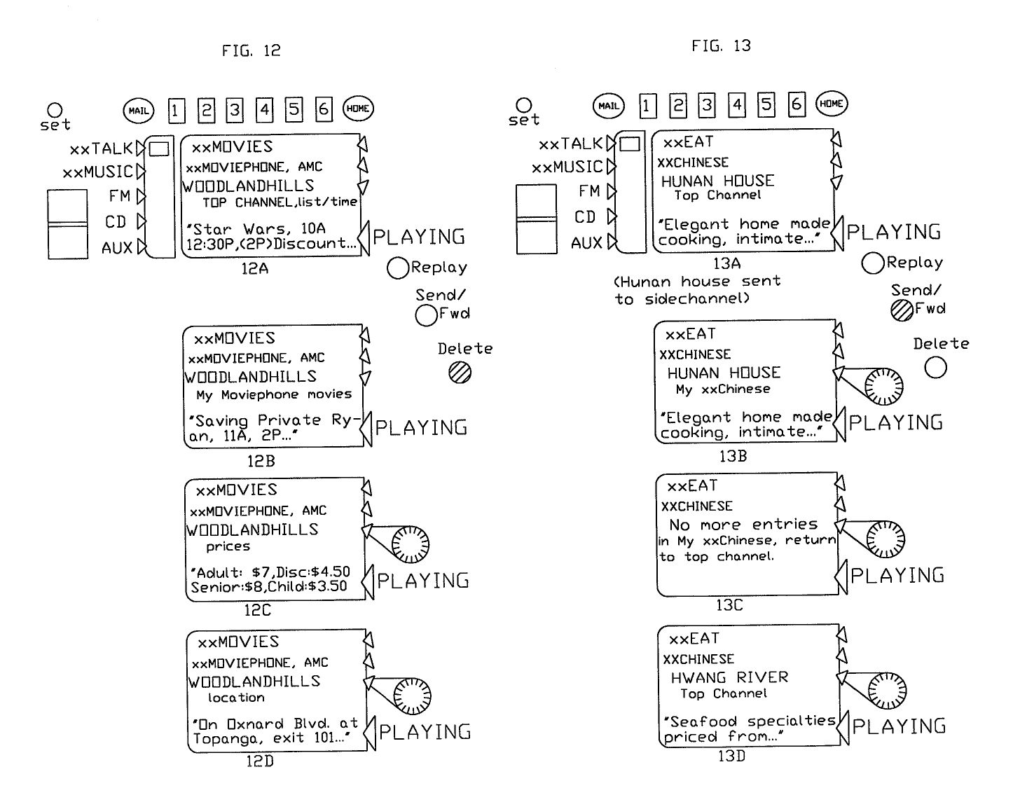

In FIG. 12 a search for local movies is shown. As with the traffic or real-estate station a default can be to seek theaters in the general area of a mobile user, or to provide a channel of the movie station specifically for selecting an area to search. In the example of FIGS. 12A and B the owners of “Moviephone” occupy multiple station positions in the xxMovies category. Separate stations are for each significant theater chain in the search area. “Moviephone” may occupy even more station spots to classify movies by title rather than theater operator. Similarly the location search option could be presented at the station level. If the network operator decides there are too many stations in the xxMovie category they may require Moviephone to move more classifications to the Channel level. This decision may be affected by the relative importance of this station owner to the network's income or other operations. Although the example of FIG. 12 shows that it can be done, it would likely be unusual for a station operator to be allowed to occupy multiple station positions. Rather the station must offer the search and modify functions at the lower levels.

Moviephone has elected to make the modify buttons work similar to a music playlist. Pressing Delete does not just skip the current selection, but creates a new playlist where the undesired title will not appear. After the delete action the station may provide “My Moviephone” channels for every theater selected, where “Star Wars” has been removed. Send/fwd would likely just skip to the next selection without modifying the playlist since adding a sidechannel may be too much detail for movie searches. Replay may replay the movie title, and add more descriptive information about the title. These modify actions could be used by Moviephone to assemble a playlist of new titles for an individual's “My Moviephone” channel as the old titles are pulled out of theaters. This is a further example of passive personalization that is a feature of the invention.

The top channel is always accessible if the user wants to hear the unmodified playlist of movie titles. According to FIG. 12 Moviephone provides four channels for each theater location. This is true whether the theater name is selected at the station level or the channel level. First is the top channel playing each location's list of features. Then My Moviephone plays the more personalized list. Next are price and whereabouts channels as in FIGS. 12C and D.

As seen in FIG. 12, the station operator has flexibility as an affiliate of the network in how the method of the invention with the device of FIG. 1 may be implemented. They can further make adjustments to their operation over time, including how to interpret the user's modify actions to personalize the user's playlist or other information.

FIG. 13 demonstrates a possible restaurant search. In the xxEat category a Chinese station has been selected. The eat category may be operated by an existing restaurant guide organization or a new company set up specifically as an affiliate of the present network. This is true for any of the other categories also. In the “Chinese” station the entries are arranged alphabetically. As with other location sensitive subjects the offerings are based on the user's current location or area selected in a special location channel, or on the user's PC. In this station each restaurant can be accessed by the channel dial. If one selection is interesting pressing Send/fwd will send it to the sidechannel, “My xxChinese”. The sidechannel selections are at one end of the dial within each station subject, Chinese in this case. Delete will remove a selection from My Chinese channel but it will just skip a selection when used within the Top channel. It is typical that the top channel cannot be modified. There is no second sidechannel since this would be redundant for local Chinese restaurant listings. FIG. 13C is a possible display where the sidechannel selections end and the top channel selections begin along the Channel dial. FIG. 13D is the selection in the Top Channel after that of FIG. 13A. It plays even if the channel dial is not turned since Hwang River is next in line.

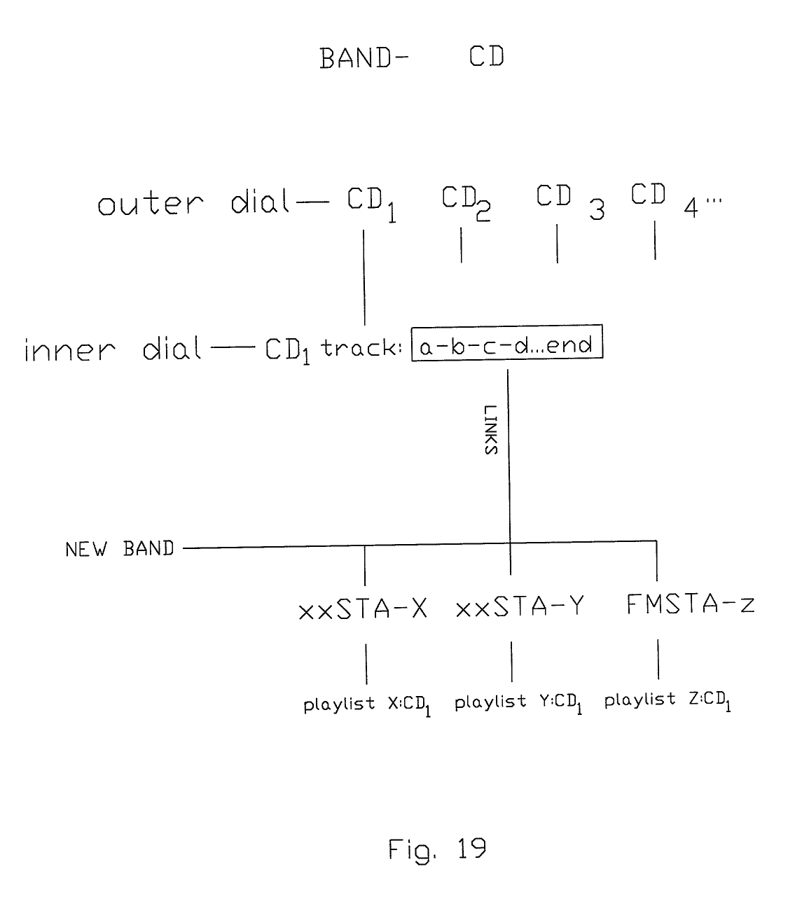

FIG. 14 shows the CD band selected, where a CD is playing. This display is related to FIG. 17, a tree diagram showing links from a CD that is playing. FIG. 19 demonstrates that the dial controls in the device of FIG. 1 can be used to operate other devices. The Category dial is referred to as the “outer” dial. As discussed earlier the dials are not labeled, so the functions of them are not fixed. In FIG. 19 the top outer dial selects the CD from a multi-CD changer. The inner dial selects the track. The channel dial could serve to search within a track. The device of FIG. 1 becomes an efficient CD searching and selecting tool.

To create a subject link to a CD, the title or contents of the CD must be known. Recent commercial CD's include identifying information. Home made CD's from MP3 downloads or other sources may include identifiers added by the person who recorded it. Earlier commercial CD's do not include such information. But it is possible to identify such a CD with a reasonable certainty using standard track number and length information. The number of tracks combined with the length of each is substantially unique to each CD, especially since the track length is known to one-second precision. With this information the title of the CD can be known, or at least reduced to just a few options, using a data base of known CD profiles. If a few CD's are possible the user may be given CD title choices by way of one of the device dials. More likely the CD title can be narrowed by knowing the user's previous music preferences. The few CD options are unlikely to be similar to each other.

The network operator provides a search function to find a station that has programming similar to or related to the material on the CD. The search function would likely use intelligent search methods. The results of the search could be prepared as soon as the CD is identified so that a link is ready for the user immediately. As a CD plays, or afterward, a user may press the “Links” button. A station is presented that has been matched to the CD. In the example of FIG. 14 a CD of Beethoven is playing. The link starts a playlist from an FM station that is playing Mozart. The link is most precise if the currently playing selection on a station is known. Otherwise, while the station may have a matched format, the current item may be one the listener prefers to Delete. In the example of FIG. 14, a standard FM station is shown. If they have an xx affiliate operation they may also make available descriptions of currently playing selections from their Top Channel. Then the network knows that Mozart is currently playing and a Beethoven listener is likely to be happy with the selection. In the case of a popular music format, knowing the precise selection playing is less essential than the playlist style since selections are shorter.

According to one embodiment the CD link takes a user to a new category xxCDlinks. The Station dial provides station selections that offer material related to the CD playing. Some stations may be music providers, others may be retailers featuring CD's related to the one playing. Others may feature interviews with the artist on the CD. Some stations may have channels providing all of the above options.

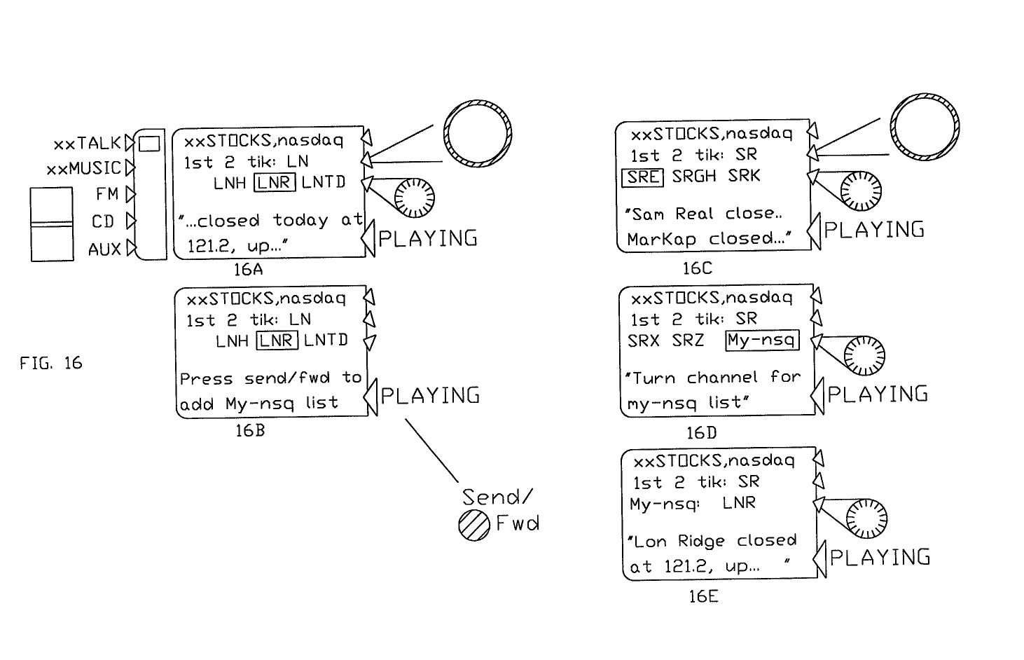

FIG. 16 shows a use of the method of the invention for accessing stock market information. The category includes the various well known stock exchanges under the xxSTOCK category. The user can create a personalized list of stocks on a PC using xxHOMEPAGE, which can be played under Homepage or the stock category. Or the category may include stations that are voice enabled wherein the search can be done by speaking. The option of speaking to conduct a search is applicable to any of the searches that are discussed in this disclosure. Certain stations may offer that option. However even with fully enabled speech recognition it may often by preferred to operate the method of the invention using device controls similar to that of FIG. 1 such as when talking may disturb others nearby.

In FIG. 16 a way to select stocks using the device controlled method of the invention is shown. The stock category may be operated by the network operator. This would be appropriate where a complicated search is being done within the limitations of the controls of a network oriented device such as in FIG. 1. FIG. 16A shows the station selector being used to select the first two letters of a stock symbol. As discussed earlier the names to describe the dials are not specified or constrained. Clearly the use of “Station” to describe the inner dial is mere a convenience here. A stock with a symbol “LNR” is being sought. The channel dial is used to select from nasdaq stocks that have the first two letters LN. The “talking screen” button would cause each stock symbol to be announced as they are selected. If the dial is moved past the selection before it can be fully or even partially announced, the announcement will be interrupted or not heard at all. If the dial is left in position for a brief time the audio system will announce “LNR”. If “talking screen” is pressed again there is no announcement, but the display will show the selections. Whether the selections are announced or not, if the selection is left in position the audio system starts describing a fictional “Lon Ridge” Co., symbol LNR as in FIG. 16A. The network or station operator may choose to offer a text only option for the playlist content. Text only may be desired for many information-only activities, and stations providing such programming may offer silent play options. A certain function of the Talking Screen button could be used.

In FIG. 16B the play may prompt the user to send the selection to a sidechannel, which he does. The user continues to turn the station and channel dials in FIG. 16C, and stops at “Sam Real”. At the end of each channel section is the sidechannel “My-nasdaq”. This same list is accessible for each two letter selection on the station dial. Since the number of channel selections remains reasonable under each station selection, it is easy to access the personalized playlist of stock choices at any time. This pattern of sidechannels at the end of a station subject is used in earlier examples above also, such as the Chinese restaurant. This “My-nasdaq” channel is also available at xxHOMEPAGE as described earlier. If the listener has created a “My-NYSE” it also would be available at “xxHOMEPAGE”. FIG. 16D is a message suggesting how to access “My-Nasdaq” list. This instruction could be part of a result of pressing the (?) button and turning the channel dial. In FIG. 16E My-Nasdaq is playing. It can be played at the end of every station subject.

In the preceding detailed description of an audio Internet navigation system numerous very specific embodiments have been described, including names of functions, search features and channels. These are not intended to limit the possible applications for or variations of the invention. One reason for such precision has been to demonstrate how the method can be readily adjusted to perform a variety of quite different realistic tasks using a consistent type of device and system. The device of FIG. 1 is shown in a specific physical form. However other devices can be used to implement the method of the invention. In fact designers would be encouraged to provide a diverse selection of devices and platforms to suit individual users of the method of the invention.

For example an entirely voice activated system could use the inventive method to organize, select and search audio programming on the Internet. A user can verbally respond to spoken prompts to specify Categories, Stations, Channels, and playlist modifying functions in a top down manner. With spoken or keyboard typed commands a bottom up search would also be efficient. Requesting a specific play item could automatically select the appropriate station and category. A user is then aware of the identity of the provider of the playing item. This concept could evolve into a broader search method, with the results well organized by who provided the selection, and easy top-down, down-up, and sideways navigation with links made according to the inventive method.

1. A method for navigating the programming of an audio program provider in which the provider presents to listeners a standardized method for searching, selecting and playing programming, wherein:
the provider offers a top channel accessible simultaneously by a plurality of listeners, wherein each listener receives substantially a same playlist;
a listener reacts to program items that are played on the top channel, a cumulative history of a listener's reactions comprising a user preference;
the provider offers an ability to create a first side channel wherein an alternate personal playlist is already prepared when the listener reacts in a first manner to a program item of the top channel;
the first side channel including programming that reflects a combination of a style of the provider of the selected top channel, and the user preference, wherein the listener creates a personal playlist of programming in near real time during the course of listening and reacting to a channel of the program provider.

2. The method of navigation of claim 1 wherein the listener may immediately select either one of the top channel and the first side channel.

3. The method of navigation of claim 1 wherein the listener's reaction includes a negative response to a program item of the top channel.

4. The method of navigation of claim 3 wherein a style of the first side channel reflects a listener's dislike of a program item of the top channel.

5. The method of navigation of claim 1 wherein the program provider is an affiliate of a network of program providers, a network operator provides guidance in methods for the program providers to assemble personal playlists, and a listener has access to distinct personal playlists on sidechannels of respective distinct program providers.

6. The method of navigation of claim 5 wherein the personal playlists substantially comprise program items from a respective provider's in-house program material.

7. The method of navigation of claim 1 wherein the first side channel includes a playlist that comprises in majority the program items of the top channel.

8. The method of navigation of claim 1 wherein the listener reacts in the first manner to program items of the personal playlist of the first side channel, and a further personalized playlist is already prepared when the listener so reacts, thereby further refining the first side channel.

9. The method of navigation of claim 8 wherein a second side channel is already prepared when the listener reacts in a second manner to a program item of either the top channel or the first side channel.

10. The method of navigation of claim 1 wherein the control device incorporates a means of input for voice commands and a means of output for listening to programming;
the audio program provider incorporates a means for interpreting and responding to a voice command;
a listener reaction comprises a voice command;
a provider offer comprises a voice reply;
the programming is accessed and retrieved by means of a wireless network connected to the Internet.

11. The method of claim 10 wherein the program provider is an affiliate of a network of program providers, a network operator provides guidance in methods for the program providers to assemble personal playlists, and a listener has access to distinct personal playlists on sidechannels of respective distinct program providers.

12. A method of navigation of the programming of an audio program provider affiliated with a network of other providers wherein:
a standardized control device is used to search, select and play programming of the providers, the providers being the operators of stations;
the control device includes a display screen to assist a listener in navigating programming;
the display screen includes distinct portions dedicated for displays of specific types of information about the programming, the respective portions of the display screen being used in a common manner among a majority of affiliated providers of the network;
a network operator guides the affiliated providers with respect to the type of information that is to be displayed in respective portions of the display screen;
a portion of the display screen describes a station identity of the program provider, and a further portion of the display screen describes a channel of programming offered by the station;
the control device includes a first input device whereby the listener can select between at least two channels of the station, including a top channel, and a side channel, the top channel being accessible simultaneously by a plurality of listeners, wherein each listener receives substantially a same playlist, and the side channel comprising an alternate playlist distinct from that of the top channel;
the listener being able to immediately select either one of the top channel and the side channel.

13. The navigation method of claim 12 wherein the first input device operates upon a non-changing portion of the display screen.

14. The navigation method of claim 13 wherein the control device includes two input devices, the first input device which operates to select a channel of the station, and a second input device which operates to select the station operated by the provider.

15. The navigation method of claim 14 wherein at least one of the first input device and the second input device is a rotatable dial.

16. The navigation method of claim 14 wherein a third input device comprises a rotatable dial positioned coaxially around the second input device, and the third input device operates to select a category of programming.

17. The navigation method of either of claim 16 wherein at least one of the second input device and the third input device operates upon a respective non-changing portion(s) of the display screen.

18. The navigation method of claim 12 wherein the side channel is accessible simultaneously by a plurality of listeners, wherein each listener receives substantially a same playlist on the alternate channel.

19. The navigation method of claim 12 wherein the side channel includes a personalized playlist that is unique to the user.

20. A method of navigation of the programming of a distinct station of an audio program provider affiliated with a network of other stations of providers wherein:
the audio program providers offer information that is of interest to users, including a top channel of each provider comprising a default playlist of information comprising distinct playlist items that are played sequentially on an audio device;
a standardized control device is used to search, select and play programming of the providers, the control device including a display screen to assist a user in navigating programming;
the control device operates in a substantially common manner when used to play programming of stations affiliated with the network;
at least one search control selector of the control device is used to control multiple levels of information, higher levels being of a relatively broad descriptive nature, and lower levels defining a style of a particular playlist of information;
the user operates a modification feature of the control device to modify the default playlist of information, thereby creating a personalized playlist of information from the default playlist of information, the at least one search control selector and the modification feature being distinct elements of the control device;
the personalized playlist of information reflecting a user's history of modifying the default playlist;
a search control selector enabling the user to immediately select either the default playlist of the top channel or the personalized playlist of information.

21. The method of navigation of claim 20 wherein a station selector comprises a search control selector, and the station selector is used to search and select the stations of affiliated providers of information.

22. The method of navigation of claim 21 wherein a further search selector comprises a channel selector which operates at a level below the station selector to search and select playlists of information within a selected station.

23. The method of navigation of claim 22 wherein a portion of the display screen is dedicated to display an identity of the station, and a further portion of the display screen is dedicated to identify a type of information that is being audibly played.

24. The method of navigation of claim 23 wherein an additional further portion of the display screen is dedicated to specifically identify the information that is being audibly played.

25. A method of payment for audio programming wherein a listener receives a default channel of programming from a station affiliated with a network of further stations, wherein:
a managing organization operates a benefit program whereby a listener receives credits for engaging in certain activities while listening to affiliated program sites;
the certain activities including at least one of: responding to surveys, responding to advertising, and paying a subscription fee:
the programming is from a top channel comprising a playlist that includes commercial advertising;
a personalized playlist is provided to the listener when the listener performs the certain activities, the personalized playlist having a reduction in commercials in relation to the top channel playlist, the reduction in commercials being proportionate to a quantity of credits the listener receives;
the listener may immediately select either one of the top channel's playlist and the personalized playlist.

26. A method of navigation of the programming of a distinct station of an audio program provider affiliated with a network of other stations of providers wherein:
at least some of the stations are owned and operated independently from each other;
the station offers a top channel accessible simultaneously by a plurality of listeners, wherein each listener receives substantially a same playlist;
a listener reacts to program items that are played on the top channel, a cumulative history of a listener's reactions comprising a user preference;
the station offers an ability to create a first side channel wherein an alternate personal playlist is already prepared when the listener reacts to a program item of the top channel, the listener is automatically switched from the top channel to the side channel when the listener reacts to the program item of the top channel, both the top channel and the side channel being immediately accessable to the listener after the side channel is created;
the first side channel including programming that reflects a combination of a style of the station that offers the selected top channel, and the user preference, wherein the listener creates a personal playlist of programming in near real time during the course of listening and reacting to a channel of the station;
a network operator provides guidance in methods for the stations to enable listeners to assemble personal playlists, and a listener has access to distinct personal playlists on sidechannels of respective distinct stations.
